(19) United States
(12) Patent Application Publication
(10) Pub. No.: US 2005/0062442 A1
(43) Pub. Date: Mar. 24, 2005

(54) Dimming adjusting/controlling device of an illuminator

(76) Inventor: John Lu, Taipei (TW)

Correspondence Address: BRUCE H. TROXELL, 5205 LEESBURG PIKE, SUITE 1404, FALLS CHURCH, VA, 22041, US

(21) Appl. No.: 10/942,840

(22) Filed: Sep. 17, 2004

(30) Foreign Application Priority Data
Sep. 18, 2003 (TW) 92216788

(51) Int. Cl. H05B 39/06

(52) U.S. Cl. 315/291; 315/362

(57) ABSTRACT

A dimming adjusting/controlling device of an illuminator, including a power source section, a microcomputer control section and a lighting drive section. The microcomputer control section includes multiple function keys and indicator lamps for adjustment and indication. The adjusting/controlling device is connected with the illuminator. By means of setting and activating of the function keys, the microcomputer control section sends out signals to the lighting drive section, whereby the illuminator is automatically gradually weakened from a bright state to a shimmery or totally extinguished state. Moreover, by means of the function keys, the brightness and modulation sequence and time period of the illuminator can be controlled.

### BACKGROUND OF THE INVENTION

The present invention is related to a dimming adjusting/controlling device of an illuminator. The dimming adjusting/controlling device can adjust the brightness as desired. Especially after the power is cut off, the illuminator can still emit light for a set time. Then the illuminator is automatically gradually weakened to a shimmery state. Therefore, the change of the illumination is smoothened so that a user can easily adapt his/her eyes to the environment. Accordingly, those adults or children afraid of sudden darkness will no more feel uncomfortable in the instant of turning off the illuminator.

It is known that human eyes can be hardly immediately adapted to suddenly changed illumination. Therefore, in the case that an illuminator of the environment is suddenly extinguished or dimmed, people will temporarily feel totally dark. This often leads to uncertainty or even fear. In the case that the sudden darkness takes place just before sleeping, some people often become emotionally unstable or even fail to fall asleep. Many people, especially children, suffer from such phenomenon.

In order to solve the above problem, generally a small-power wall light or table light is installed in the bedroom. After the main light is turned off, the subsidiary light can still shimmer to avoid possible fear of children. However, the wall light or table light will still emit light with a fixed brightness which may be too strong or too weak. The lighting time and brightness of the wall light or table light cannot be set. In the case that the brightness of the light emitted from the wall light or table light is too weak, in the instant of turning off the main light, a user will still feel sudden darkness.

### SUMMARY OF THE INVENTION

It is therefore a primary object of the present invention to provide a dimming adjusting/controlling device of an illuminator. By means of the dimming adjusting/controlling device, the illuminator can be gradually weakened from a bright state to a shimmery or totally extinguished state. Therefore, the uncertainty caused by sudden extinction of the illuminator can be avoided. Also, the danger caused by sudden shutoff of the environmental illuminator can be avoided.

According to the above object, the dimming adjusting/controlling device of the illuminator of the present invention includes a power source section, a microcomputer control section, a lighting drive section and multiple function keys. The adjusting/controlling device is connected with the illuminator. By means of controlling of the function keys, the brightness and modulation sequence and time period of the illuminator can be controlled. Therefore, the illuminator can be automatically gradually weakened from a bright state to a shimmery or totally extinguished state.

The present invention can be best understood through the following description and accompanying drawings wherein:

### BRIEF DESCRIPTION OF THE DRAWINGS

FIG. 1 is a perspective view of the present invention;

FIG. 2 is a block diagram of the present invention;

FIG. 3 is a perspective view of a first embodiment of the present invention;

FIG. 4 is a perspective view of a second embodiment of the present invention;

FIG. 5 is a perspective view of a third embodiment of the present invention; and

FIG. 6 is a brightness-to-time curve diagram of the illuminator of the present invention when the automatic weakening button is pressed.

### DETAILED DESCRIPTION OF THE PREFERRED EMBODIMENTS

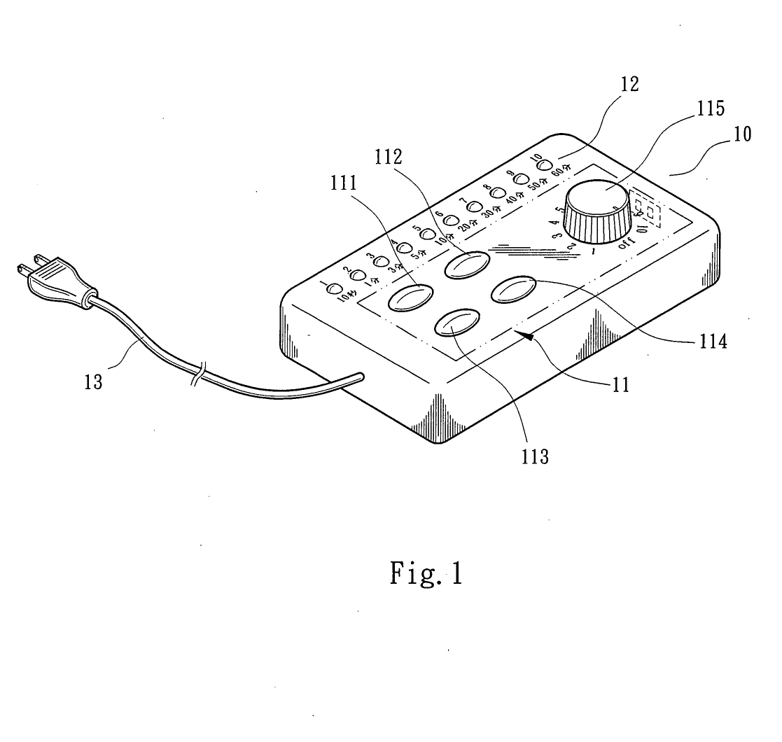

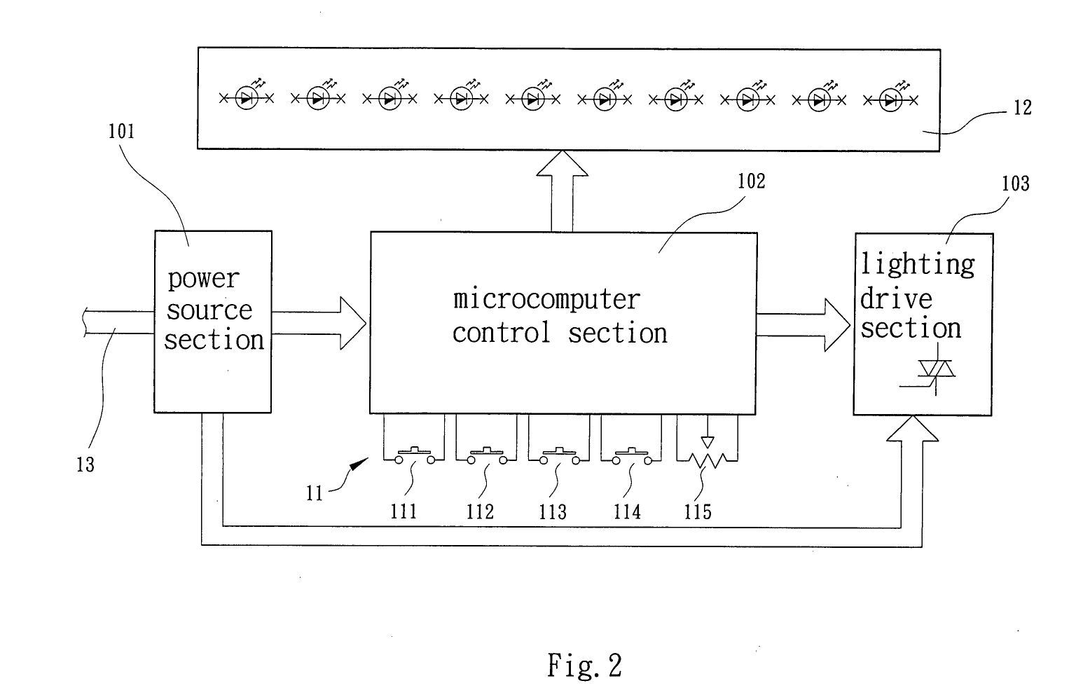

Please refer to FIG. 1. The present invention includes a housing 10 and multiple function keys 11 and indicator lamps 12 arranged on outer side of the housing 10. A power cable 13 extends from the housing 10 for connecting with a power source. In the housing 10 are disposed a power source section 101, a microcomputer control section 102 and a lighting drive section 103 as shown in FIG. 2. The power cable 13 is directly connected to the power source section 101 which provides power to the microcomputer control section 102 and the lighting drive section 103. The microcomputer control section 102 includes an activating switch 111, a strengthening button 112, weakening button 113, automatic weakening button 114 and shimmer adjustment button 115.

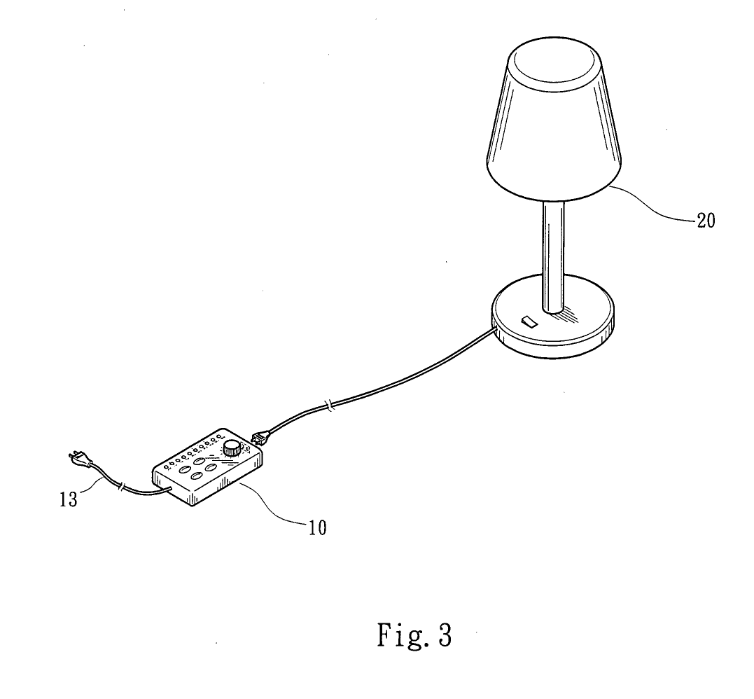

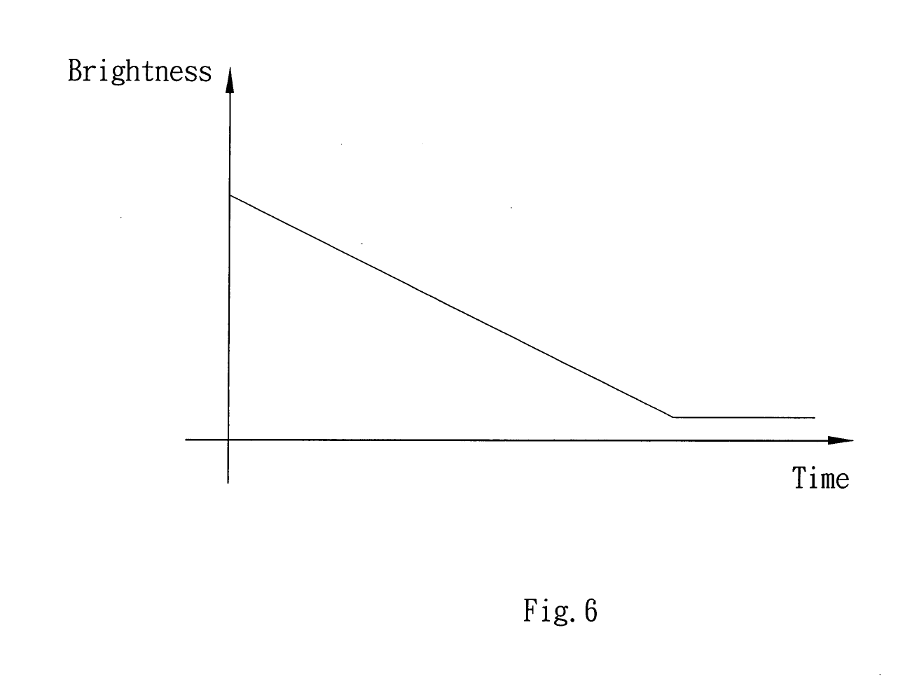

Referring to FIG. 3, according to a first embodiment of the present invention, housing 10 is connected with an external main light 20. The power cable 13 is plugged into a socket. The power source section 101 provides power for the microcomputer control section 102 and the lighting drive section 103. In common use, when pressing the activating switch 111 once, the microcomputer control section 102 sends out a turning on signal to the lighting drive section 103. After the lighting drive section 103 receives the turning on signal, the main light 20 is lighted up. When the activating switch 111 is again pressed, the microcomputer control section 102 sends out a turning off signal to the lighting drive section 103. At this time, the main light 20 is totally extinguished. When pressing the weakening button 113 or the strengthening button 112 at least once, the microcomputer control section 102 will change the indication position of the indicator lamps 12 according to the number of times of pressing so as to indicate the maximum brightness. Simultaneously, the microcomputer control section 102 sends out a set brightness change signal to the lighting drive section 103, whereby the main light 20 only emits light with the set brightness. When pressing the automatic weakening button 114 once, the microcomputer control section 102 will change a section of the indicator lamps to show the time adjustment position. In the case that the automatic weakening button 114 is continuously pressed, the shown time position of the indicator lamps is automatically changed so as to indicate the adjustment extent of the time. When the button is released, the set dimming time period is stored in the microcomputer control section 102. Then, the microcomputer control section 102 continuously sends out signal to the lighting drive section 103, whereby the light emitted by the main light 20 is gradually weakened from high brightness to the preset weakest brightness during the set time period. FIG. 6 shows a brightness-to-time curve diagram of the main light 20 when the automatic weakening button 114 is pressed. The weakest brightness can be preset by the shimmer adjustment button 115. The value of the shimmer adjustment button 115 can be adjustably set by an electricity adjustment member such as a variable resistor.

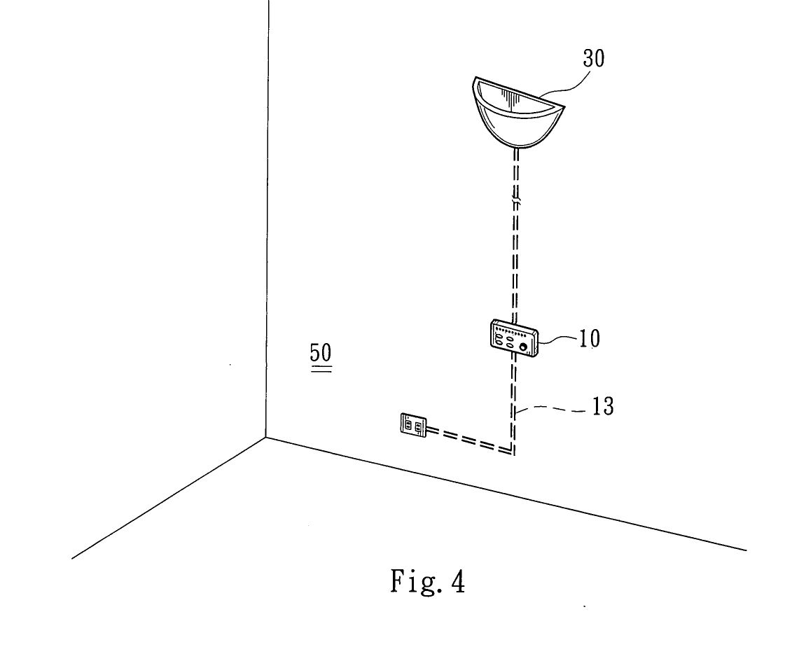

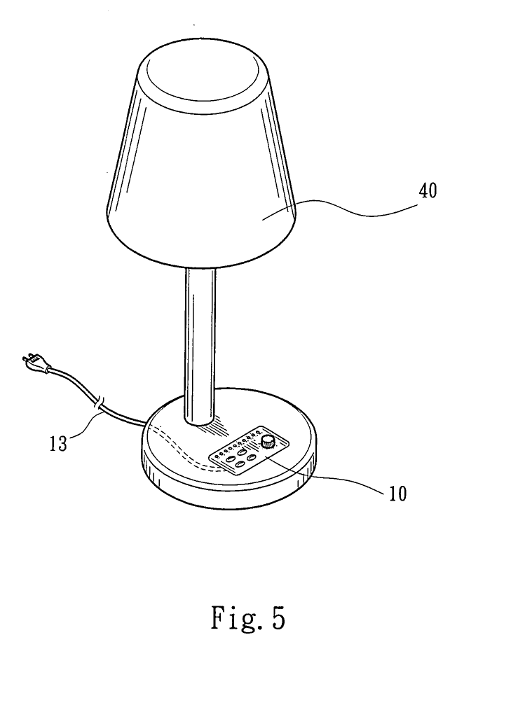

Alternatively, the present invention can be connected to an indoor fixed main light or wall light 30. FIG. 4 shows a second embodiment of the present invention, in which the housing 10 is directly mounted on a wall 50 and connected to a fixed main light or wall light 30 on the wall 50. Accordingly, the brightness of the fixed main light or wall light 30 can be strengthened, weakened, automatically weakened and adjusted in shimmer extent. FIG. 5 shows a third embodiment of the present invention, in which the housing 10 is integrally connected with a desk light 40 (or other movable illuminator such as a flashlight or portable illuminator). The power source section 101 of the housing 10 can be AC or DC type (not shown).

According to the above arrangement, the present invention has the following advantages:
1. By means of the setting of the present invention, the adjustment of the indoor illumination is smoothened and humanized. Those adults or children afraid of darkness will no more feel terrible in the instant of turning off the illuminator. Therefore, the sleeping quality of those people can be enhanced. Also, the danger caused by sudden shutoff of the environmental illuminator can be avoided.
2. The ultimate shimmer emitted by the illuminator can be set as desired. Therefore, the indoor light will not be too strong to affect the sleep. Also, the light will not be too dark to cause fear.
3. The adjustment device can have AC or DC or AC/DC convertible circuit. Therefore, a user can selectively use AC or DC power as desired.

The above embodiments are only used to illustrate the present invention, not intended to limit the scope thereof. Many modifications of the above embodiments can be made without departing from the spirit of the present invention. For example, the indicator lamps can be replaced with an image display panel to achieve the same indication effect.

1. A dimming adjusting/controlling device of an illuminator, comprising:
a power source section for providing necessary power to the device;
a microcomputer control section having setting/adjusting function, the microcomputer control section including multiple function keys for activating and regulating the function, the a microcomputer control section further including an indicator unit for indicating the state of the device; and
a lighting drive section connected to an illuminator, whereby by means of setting and activating of the function keys, the microcomputer control section sends out function change signal to the lighting drive section, whereby the light emitted by the illuminator is gradually weakened from high brightness to a preset weakest brightness during a preset time period.

2. The dimming adjusting/controlling device of the illuminator as claimed in claim 1, wherein the power source section is equipped with an AC/DC conversion circuit, whereby the power source section can be connected to an external AC power supply or a DC cell box.

3. The dimming adjusting/controlling device of the illuminator as claimed in claim 1, wherein the power supply of the power source section is an inbuilt DC cell.

4. The dimming adjusting/controlling device of the illuminator as claimed in claim 1, wherein the indicator unit is a row of indicator lamps.

5. The dimming adjusting/controlling device of the illuminator as claimed in claim 1, wherein the indicator unit is an image display panel.

6. The dimming adjusting/controlling device of the illuminator as claimed in claim 1, wherein the function keys of the microcomputer control section include an activating switch, a strengthening button, a weakening button, an automatic weakening button and a shimmer adjustment button.

7. The dimming adjusting/controlling device of the illuminator as claimed in claim 4, wherein the function keys of the microcomputer control section include an activating switch, a strengthening button, a weakening button, an automatic weakening button and a shimmer adjustment button.

8. The dimming adjusting/controlling device of the illuminator as claimed in claim 5, wherein the function keys of the microcomputer control section include an activating switch, a strengthening button, a weakening button, an automatic weakening button and a shimmer adjustment button.

9. The dimming adjusting/controlling device of the illuminator as claimed in claim 1, wherein the illuminator is a movable light.

10. The dimming adjusting/controlling device of the illuminator as claimed in claim 4, wherein the illuminator is a movable light.

11. The dimming adjusting/controlling device of the illuminator as claimed in claim 5, wherein the illuminator is a movable light.

12. The dimming adjusting/controlling device of the illuminator as claimed in claim 6, wherein the illuminator is a movable light.

13. The dimming adjusting/controlling device of the illuminator as claimed in claim 9, wherein the adjusting/controlling device is integrally combined with the light.

14. The dimming adjusting/controlling device of the illuminator as claimed in claim 10, wherein the adjusting/controlling device is integrally combined with the light.

15. The dimming adjusting/controlling device of the illuminator as claimed in claim 11, wherein the adjusting/controlling device is integrally combined with the light.

16. The dimming adjusting/controlling device of the illuminator as claimed in claim 12, wherein the adjusting/controlling device is integrally combined with the light.

17. The dimming adjusting/controlling device of the illuminator as claimed in claim 1, wherein the illuminator is a main light or wall light fixed indoors.

18. The dimming adjusting/controlling device of the illuminator as claimed in claim 4, wherein the illuminator is a main light or wall light fixed indoors.

19. The dimming adjusting/controlling device of the illuminator as claimed in claim 5, wherein the illuminator is a main light or wall light fixed indoors.

20. The dimming adjusting/controlling device of the illuminator as claimed in claim 6, wherein the illuminator is a main light or wall light fixed indoors.
